(19) United States
(12) Patent Application Publication
(10) Pub. No.: US 2002/0038153 A1
(43) Pub. Date: Mar. 28, 2002

(54) Power socket incorporating power line carrier communications and physical asset tracking and management system using such socket

(76) Inventors: Guillermo Amodeo, Largs (GB); Andrew L. Massey, Le Vesinet (FR)

Correspondence Address: Blanche E. Schiller, Esq., HESLIN & ROTHENBERG, P.C., 5 Columbia Circle, Albany, NY, 12203, US

(21) Appl. No.: 09/853,328

(22) Filed: May 11, 2001

(30) Foreign Application Priority Data
May 13, 2000 (GB) 0011492.6

(51) Int. Cl. G06F 13/00

(52) U.S. Cl. 700/1; 710/300

(57) ABSTRACT

A power line connection socket for use with a building power line circuit is disclosed. The power line connection socket includes connectors for connecting the power line connection socket to a building power line circuit, connectors for attachment of an asset, wherein the asset receives power from the building power line circuit through the power line connection socket. The power line connection socket also includes a power line modem for transmission of data via the building power line circuit and a unique identifier associated with the power line connection socket for transmission by the power line modem via the building power line circuit. An asset monitor, associated with an asset, is also disclosed.

### Prior Foreign Application

This application claims priority from United Kingdom patent application number 0011492.6, filed May 13, 2000, which is hereby incorporated herein by reference in its entirety.

### TECHNICAL FIELD

The present invention relates to a power socket incorporating power line carrier communications and a system for tracking the location of assets by means of transmission of a unique identifier from the asset to a tracking system using such a power socket.

### BACKGROUND ART

In any organization where physical information technology (IT) hardware assets such as personal computers, mobiles computers, server computers and printers are used, it is important to effectively manage each asset. One area of IT asset management which is regarded as time consuming, difficult and very expensive, is recording the physical position of each IT asset. The problem is further exacerbated with the present large scale adoption of mobile computing and printing devices, which are easily transported, but are difficult to track. Losing control of the physical location of assets leads to accounting irregularities and investment planning disruption.

The most widely adopted method is physical inventory taking. This involves identifying and recording each asset by either physically going to it, or getting users to send data to a central point. This is not a good solution because:

(i) Users don't always respond;

(ii) Data is only current for that moment in time, i.e. a user can enter data and then move the asset;

(iii) Is not very secure; and

(iv) Is time consuming.

Integrated management applications like Tivoli Enterprise and similar generally rely on information entered by hand either at the managed system or at the management console to identify the system's location (Tivoli is a trademark of Tivoli Inc). Often this information becomes out of date because the person moving the system is not aware that the information has to be updated, or how to update it.

As systems management and troubleshooting becomes more automated, and pre-emptive maintenance is becoming more prevalent, alerts to the system manager that intervention is required at a remote system will come from the system itself, not the user, so it is imperative that location information is kept up to date. As an example, a bank branch system may report that intervention is required and as a result of the report, a technician is dispatched to the wrong town because the asset database is out of date.

GB Patent Application 9920722.7 discloses a method of tracking assets within a building using a radio device associated with each asset to be tracked and an array of transmitting beacons. Each of the beacons transmits identification data. The received identification data from the asset to be tracked is sent to a server which determines the location of the asset. The identification data may be sent from the asset to the server using a data communications network such as a local area network.

IBM Technical Disclosure Bulletin v.24, n.1B., June 1981, pages 576-7, discloses a method for deterring the theft of office product equipment, such as typewriters. A low power transmitter, adapted to transmit along the power line is installed within the typewriter. If the typewriter is disconnected from the power line, then the absence of the transmitted signal is detected and an alarm can be activated at a monitoring station. This disclosure does not provide any means for identifying the location of the asset to be tracked, only the removal of the asset from a power supply connector.

U.S. Pat. No. 5,072,370 discloses data processing equipment in which a prompted-for userid and an identifier unique to the machine is transmitted via a power line modem to a host computer. The transmitted data does not provide any means for identifying the location of the data processing equipment.

So it would be desirable to provide a method of tracking the location of assets which did not require the additional costs of beacons located throughout a building.

### SUMMARY OF THE INVENTION

Accordingly, the present invention provides a power line connection socket for use with a building power line circuit, the power line connection socket including, for instance, one or more connectors for connecting the power line connection socket to a building power line circuit; one or more connectors for attachment of an asset, wherein the asset receives power from the building power line circuit through the power line connection socket; a power line modem for transmission of data via the building power line circuit; and a unique identifier associated with the power line connection socket for transmission by the power line modem via the building power line circuit.

In one embodiment, the power line modem is capable of receiving transmissions from an attached asset and of merging the transmissions with the unique identifier for retransmission via the building power line circuit.

The invention also provides an asset monitor for use, with a power line connection socket as described above, in an asset tracking system, the asset monitor including, for instance, a unique identifier associated with the asset monitor; and a power line modem for transmission of data, including the unique identifier, from the asset monitor to the power line connection socket.

An asset monitor which transmits a unique identifier associated with the asset, together with a unique identifier associated with a power line connection socket to which it is connected has the advantage that an asset can be detected whenever it is connected to the building power line circuit. With the exception of mobile devices which use non-rechargeable batteries as their power source, all assets need to be connected to the building power line circuit at some time and so the present invention provides a way to precisely track the location of such notoriously difficult to track assets.

In one embodiment, the asset to be tracked is a piece of data processing equipment, however the invention is applicable to any asset which at any time requires power from a building power line circuit.

The invention further provides an asset tracking system including, for instance, an asset monitor as described above and a management server having a power line modem connected to the building power line circuit, the management server storing the unique identifier associated with an asset together with the unique identifier associated with a power line connection socket.

### BRIEF DESCRIPTION OF THE DRAWINGS

Embodiments of the invention will now be described, by way of example, with reference to the accompanying drawings, in which:

FIG. 1 is a tracking system according to the present invention;

FIG. 2 is a block diagram of the power line connection socket of FIG. 1 and the asset to be tracked of FIG. 1;

FIG. 3 is a flow diagram of the logic applied in a power line connection socket into which an asset to be tracked has been plugged;

FIG. 4 is a flow diagram of the logic applied in an asset to be tracked;

FIG. 5 is a flow diagram of the logic applied in a power line connection socket into which a management server has been plugged; and

FIG. 6 is a block diagram of component parts of a management server of FIG. 1.

### BEST MODE FOR CARRYING OUT THE INVENTION

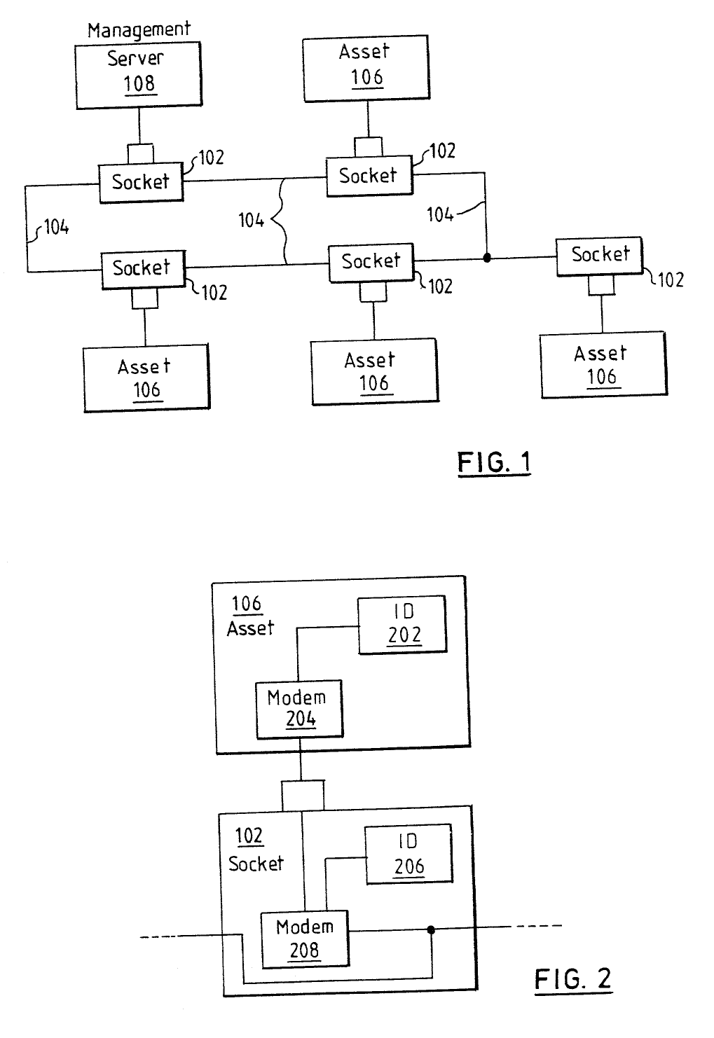

Referring firstly to FIG. 1, a system in which the present invention may be implemented is shown. A plurality of power line sockets 102 are connected to a conventional building power line circuit 104 for the distribution of AC power to assets 106, 108 throughout a building. The power line sockets 102 may be any conventional power line socket 102 such as is normally used for the distribution of power around a building. The size and style of the sockets 102 and even the number of pins is not important for the present invention and will vary between different countries.

An application of the socket 102 described above is in an asset tracking system. An asset 106 whose location is to be tracked obtains its AC power from a power line socket 102 connected to the building power line circuit 104. A management server 108 which tracks the locations of the assets 106 to be tracked also obtains its AC power from a power line socket 102 connected to the building power line circuit 104. The asset 106 to be tracked may be a personal computer, a mobile personal computer, a printer, a monitor, a server or any other piece of electrical equipment.

FIG. 2 shows a block diagram of the power socket and the asset 106 to be tracked. The asset to be tracked contains, in addition to all of the items required for its normal functioning, a unique identifier 202 contained within the asset. This unique identifier is transmitted by a power line modem 204 to the power line socket 102 into which the asset 106 is plugged into. The power line socket 102 receives the transmission from the power line modem 204 and adds an identifier 206 unique to the power line socket 102 to the unique identifier 202 of the asset. The power line socket includes a power line modem for the receipt of transmissions from the power line modem within the asset 106 and for transmitting onto the building power line circuit.

In a first embodiment, the addition of the unique identifier may be by way of the power line socket 102 decoding the unique identifier transmitted by the asset 106, adding its own unique identifier and then transmitting the combined identifier. In a second embodiment, the addition of the unique identifier may be by way of the power line socket 102 transmitting its unique identifier immediately after the unique identifier associated with the asset 106 has been transmitted by the asset 106 itself. In a third embodiment, the addition of the unique identifier may be by way of the power line socket 102 transmitting an identifier consisting of its own unique identifier plus the identifier associated with the asset after the unique identifier associated with the asset 106 has been transmitted by the asset 106 itself. In other words, the power line socket 102 may intercept the transmission from the asset 106 and transmit a merged identifier or it may transmit its own identifier only after the asset identifier has been transmitted or it may retransmit a merged identifier. In the present description, the first embodiment will be described in detail, but the principles elaborated are easily implemented by those skilled in the art using the second or third embodiments.

The power socket 102 is responsible not only for supplying power to the asset, but also for controlling and interfacing the transmission of unique identifier associated with the asset and the unique identifier associated with the power socket to the management server 108 which tracks the location of the assets 106, via power line communications. The power socket may be controlled using a controller such as one conforming to the CEway PL-One or CEway PL-111 specification.

A management server 108 which tracks the locations of the assets 106 receives the transmitted identifier or identifiers via the conventional building power line circuit 104. The location of each asset 106 can be determined because of the unique identifier associated with each power socket 102 which is transmitted along with the asset identifier. The management server 108 has a database which contains the physical location of each of the power sockets. Given the asset identifier and the socket identifier the asset management software can determine the physical position of the asset.

Each asset to be tracked is to have a unique identifier. The personal computer industry is currently specifying a standard that states that each asset is to have a UUID number (Universally Unique IDentification). This 128 bit number is programmed into non-volatile memory on the system board at the time of manufacture. The UUID number may also be combined with data residing in a system's VPD (Vital Product Data) storage. In this manner, the exact model and serial number of the system can be determined by the management server.

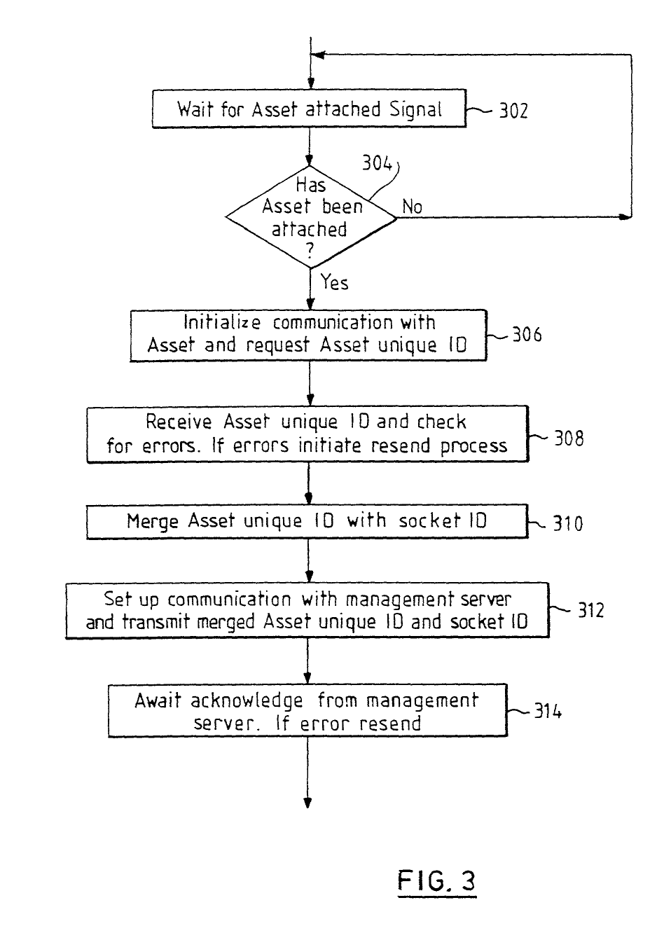

Referring to FIG. 3, the logic applied in a power line connection socket into which an asset has been plugged into is shown in flow chart form. At steps 302 and 304, the power line connection socket 102 waits for a signal indicating that an asset has been plugged into the power socket 102. When an asset 106 has been plugged into the power socket 102, the power socket, at step 306, initializes communication with the asset and requests the asset's unique identifier. At step 308, the unique identifier associated with the asset 106 is received and checked for errors. If there are errors, then communication is reinitialized and the unique identifier again requested. At step 310, the unique asset identifier is merged with the unique socket identifier. At step 312, communication is established with the management server 108 and the merged identifier is transmitted to the management server 108. An acknowledgement should optionally be received at step 312 from the management server. The receipt of an acknowledgement is not essential to the operation of the invention, but if implemented and an acknowledgement has not been received, then the merged identifier is resent and an acknowledgement again awaited.

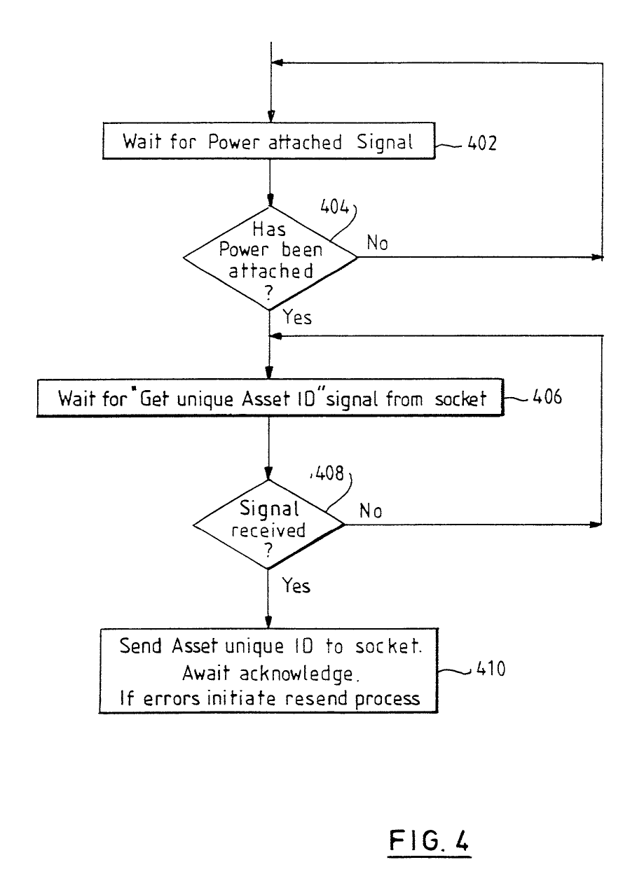

Referring to FIG. 4, the logic applied in an asset to be tracked is shown in the form of a flow chart. At steps 402 and 404, the asset 106 waits for a signal indicating that the asset 106 has been plugged into a power socket 102. When this signal is received, at steps 406 and 408, the asset waits for a “Get Unique Asset ID” request from the power socket 102. When the request is received, the asset 106 sends its unique identifier to the power socket 102. An acknowledgement should optionally be received at step 410 from the power socket. The receipt of an acknowledgement is not essential to the operation of the invention, but if implemented and an acknowledgement has not been received, then the unique identifier is resent and an acknowledgement again awaited.

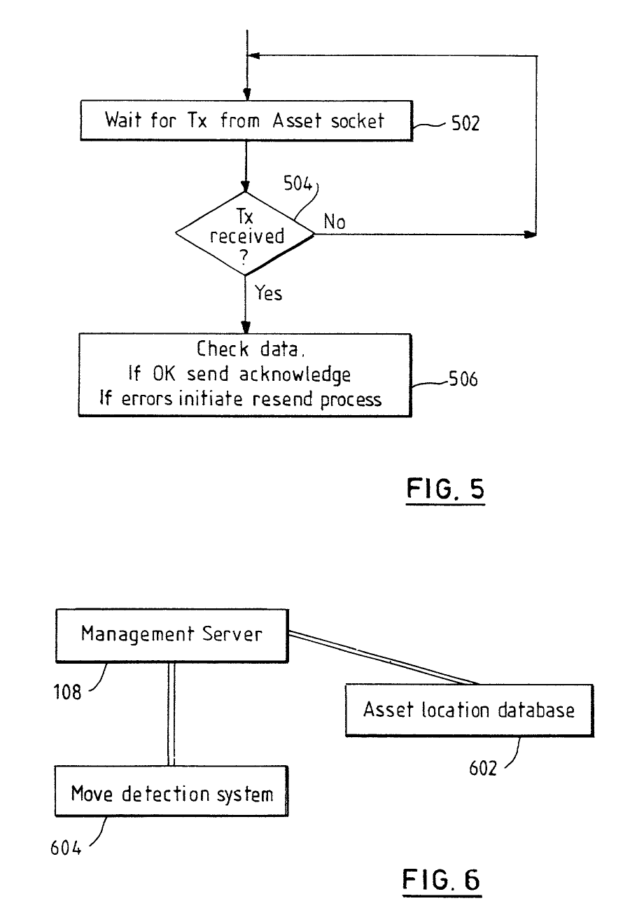

Referring to FIG. 5, the logic applied at the management server 108 is shown in the form of a flow chart. At steps 502 and 504, the management server 108 waits for a transmission from a socket into which an asset has been plugged. At step 506, a transmission has been received. The transmission data is checked and if it is received satisfactorily, an acknowledgement is sent, otherwise a resending process is initiated.

Referring to FIG. 6, which shows, in block diagram form, the component parts of a system according to the present invention. When the management server 108 has determined the asset 106 location, it records the location in the asset location database 602. The data recorded may, for example be the asset unique identifier and the unique identifier associated with the socket 102. It may optionally report the position of the asset 106 to a move detection system 604 or to a management system such as Tivoli Enterprise. (Tivoli is a trademark of Tivoli Inc). The Common Information Model of the Desktop Management Task Force defines standardized ways of making asset location data or alerts available to management systems. The Desktop Management Task Force is a consortium including Intel, IBM, SunSoft, Microsoft, Novell, SCO, HP, NEC, Symantec, DEC, Dell and Compaq. The Common Information Model (CIM) is a scheme for describing management information that is used to tie together existing differing management applications. Using this standard, the location information and move alerts could be integrated into any enterprise management system without special programming.

The power line modem 204 may need to include circuitry to transfer the unique identifier 202 across an isolating transformer, such as are frequently used for mobile devices. This circuitry may be one or more capacitors used to couple the signal from the power line modem across the windings of the isolating transformer, whilst maintaining the isolation characteristics of the transformer itself. Similar circuitry may be required within a building to couple the power line modem signals between phases of the electricity supply. Such circuitry is typically a capacitor having a high impedance at the electricity supply frequency (typically 50 or 60 Hz) and a low impedance at the power line modem transmission frequency (typically 120 kHz). The requirements, such as insulation resistance and creapage/clearance distances and application of such circuitry is well known to those skilled in the art and will not be described further. It is also possible that such circuitry may be required if an uninterruptible power supply (UPS) is used in order to couple the signal between the socket supplying the asset 106 and the socket connecting to the building power line circuit 104.

Similarly, it may be necessary to prevent leakage of the power line transmissions out of the building or interference to the power line transmissions entering the building from outside. If such isolation of transmission is required, then the techniques for achieving this are well known and include the use of bifilar wound inductors having both active conductors of the power line transmission circuit passing through a common core made of ferrite or similar material.

In the event that a socket 102 is removed from the building power line circuit 104 and reused elsewhere at a later date it is possible that erroneous location information may be provided. A solution to this problem is for the management server 108 to identify when a socket 102 “disappears” from the building power line circuit 104 and to keep a list of such identified sockets. When the sockets “reappear”, then the management server 108 can issue an alert that the physical position of the socket 102 needs to be manually verified.

A power line connection socket for use with a building power line circuit is disclosed. The power line connection socket includes connectors for connecting the power line connection socket to a building power line circuit, connectors for attachment of an asset, wherein the asset receives power from the building power line circuit through the power line connection socket. The power line connection socket also includes a power line modem for transmission of data via the building power line circuit and a unique identifier associated with the power line connection socket for transmission by the power line modem via the building power line circuit.

An asset monitor, associated with an asset, is also disclosed. The asset monitor is for use, with the power line connection socket described above. The asset monitor is supplied with power from the power line connection socket, in an asset tracking system, the asset monitor comprises a unique identifier associated with the asset monitor, and a power line modem for transmission of data, including the unique identifier, from the asset monitor to the power line connection socket. An asset tracking system is also disclosed, comprising of the asset monitor described above and a management server having a power line modem connected to the building power line circuit. The management server stores the unique identifier associated with an asset together with the unique identifier associated with a power line connection socket.

While the preferred embodiments have been described here in detail, it will be clear to those skilled in the art that many variants are possible without departing from the spirit and scope of the present invention.

What is claimed is:

1. A power line connection socket for use with a building power line circuit, the power line connection socket comprising:
one or more connectors for connecting the power line connection socket to a building power line circuit;
one or more connectors for attachment of an asset, wherein the asset receives power from the building power line circuit through the power line connection socket;
a power line modem for transmission of data via the building power line circuit; and
a unique identifier associated with the power line connection socket for transmission by the power line modem via the building power line circuit.

2. A power line connection socket as claimed in claim 1 wherein the power line modem is capable of receiving transmissions from an attached asset and of merging the transmissions with the unique identifier for retransmission via the building power line circuit.

3. A power line connection socket as claimed in claim 1 wherein the power line modem is capable of receiving transmissions from an attached asset and transmits the unique identifier associated with the power line connection socket via the building power line circuit after the transmission of the attached asset.

4. A power line connection socket as claimed in claim 1 wherein the power line modem is capable of receiving transmissions from an attached asset and transmits the unique identifier associated with the power line connection socket together with a unique identifier received from the attached asset via the building power line circuit after the transmission of the attached asset.

5. An asset monitor, associated with an asset, the asset monitor being for use, with a power line connection socket as claimed in claim 1, the asset monitor being supplied with power from the power line connection socket, in an asset tracking system, the asset monitor comprising:
a unique identifier associated with the asset monitor; and
a power line modem for transmission of data, including the unique identifier, from the asset monitor to the power line connection socket.

6. An asset monitor as claimed in claim 5, wherein the asset with which the asset monitor is associated with is data processing equipment.

7. An asset tracking system comprising the asset monitor of claim 5 and a management server having a power line modem connected to the building power line circuit, the management server storing the unique identifier associated with an asset together with the unique identifier associated with a power line connection socket.
